(19) United States
(12) Patent Application Publication
(10) Pub. No.: US 2004/0149252 A1
(43) Pub. Date: Aug. 5, 2004

(54) Rotary, electromagnetic, internal combustion engines

(76) Inventor: Joseph D. Udy, Aurora, CO (US)

Correspondence Address: Joseph D. Udy, Apt. #362, 4466 S. Helena Way, Aurora, CO, 80015-4415, US

(21) Appl. No.: 10/357,547

(22) Filed: Feb. 4, 2003

(51) Int. Cl. F02B 53/00

(52) U.S. Cl. 123/245

(57) ABSTRACT

Rotary, electromagnetic, internal combustion, engines utilize magnetic fields, generated by electromagnets, to control the momentum of dependently rotating impellers.

### BACKGROUND

1. Field of Invention

This invention relates to rotary internal combustion engines and specifically to rotary internal combustion engines with dependently rotating impellers on a shared, power output shaft, and with magnetic field control of impeller momentum.

2. Prior Art

The prior art of rotary internal combustion engines includes more than 400 patents. Bakhtine, U.S. Pat. No. 6,293,775, is a state of the art patent that describes a dual drive shaft mechanical device. Vanmoor, U.S. Pat. No. 6,257,195, describes impellers in an air injection system. All of the prior art describes mechanical devices.

### OBJECTS AND ADVANTAGES

This engine appears to be unique, and novel, in demonstrating a new class of rotary internal combustion engines as mechanical-electromagnetic devices.

This preliminary, simple, preferred embodiment, has about ten moving parts, including clutches and the power shaft, and illustrates the engine concept. There are a very large number of embodiments, each with variations in dimension and configuration and materials. These embodiments would be designed to be useful in some selected applications.

### SUMMARY

Rotary, electromagnetic, internal combustion engines, utilize dependently rotating impellers, on a shared, single axis, and electromagnetic fields to control the momentum of the rotating impellers.

### DRAWINGS, BRIEF

FIG. 1, a rotary, internal combustion, engine cycle.

FIG. 2, views of impellers on power shaft assembly.

FIG. 3, views of impeller segments.

FIG. 4, view of engine case.

FIG. 5, view of end caps and clutches.

FIG. 6, profile and transparent views of clutch.

FIG. 7, views of engine assembly.

### DRAWINGS, DETAILED

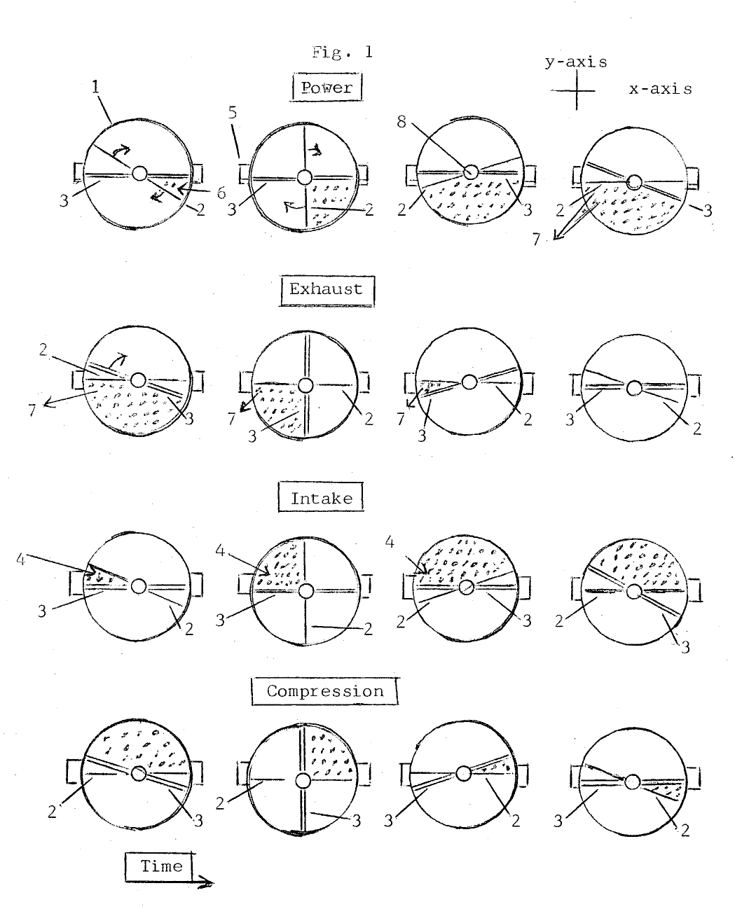

FIG. 1. Rotary, internal combustion, engine cycle: utilizing a pair (two) of 2 vane impellers rotating alternately 180 degrees clockwise, on a shared power output shaft. Illustrated separately, these functions occur simultaneously in respective sectors.

FIG. 1; the engine case interior wall 1, contains a power shaft 8 (projecting along the z axis) with two, dependently rotating (independent hubs), two vaned impellers 2 and 3.

The power function starts with electromagnets 5, locking both vanes (sides) of impeller 3 into position (static). Impeller 2 (dynamic) rotates slightly by magnetic repulsion and fuel is injected 6, into a compressed air charge (sector), ignition/spontaneous combustion occurs. Combustion products force (power) impeller 2 to rotate, at about 160 degrees the electromagnets 5 reverse the magnetic field, impeller 3 is repulsed (now dynamic), the magnetic field is reversed again and impeller 2 is locked into position (now static) by the electromagnets 5 and the function repeats. The other sectors execute the respective functions, as illustrated.

The power sector provides power for the exhaust sector and the intake sector and the compression sector and output power at the power shaft.

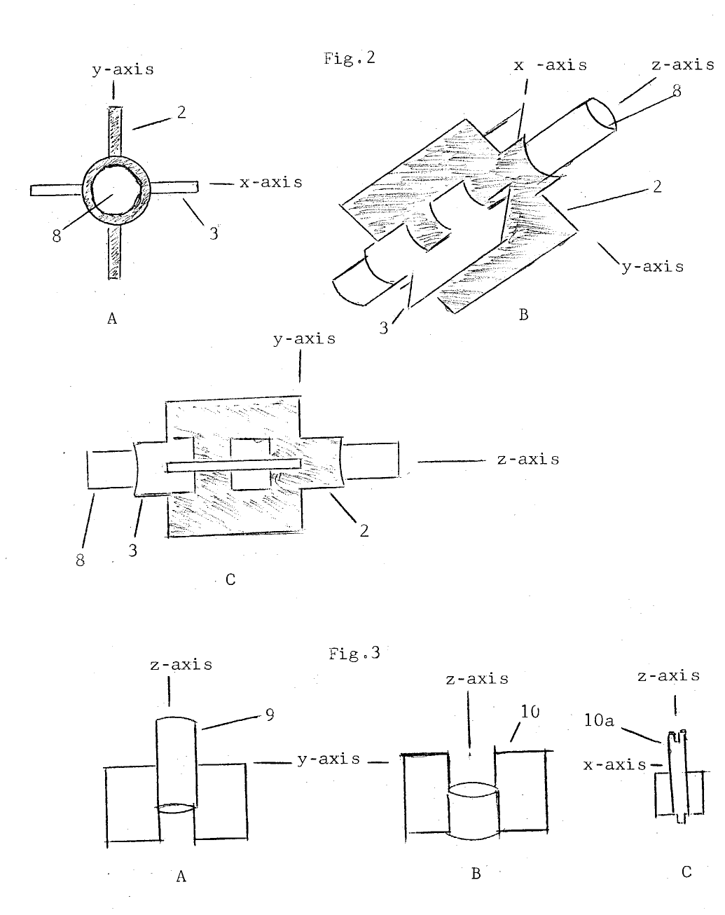

FIG. 2 shows views of the impellers, 2 and 3 assembled onto the power shaft 8. FIG. 3 shows views of the impeller segments used to assemble the impellers 2 and 3. The end impeller segments 9, have an extended hub to reach through the end cap 11. The interior impeller segments 10, can be stacked alternately with gas tight seals (not shown) to build the impellers, 2 and 3, on the power shaft.

The respective impeller vanes could have machined joints 10a and be friction stir welded to form monolithic impeller vanes.

To achieve magnetic field control of impeller momentum during rotation (engine operation) electromagnets built into the impeller vanes will likely be required. Depending on the vane/impeller material, these vane electromagnets may be homogeneous, except for implanted wire coils (insulated). The contacts (not shown), for the electromagnet wire coils (not shown) of the impeller vane electromagnets, could be deep in the machined joints 10a, and the vane surfaces, friction stir welded. The control circuit could be internally wired to the respective impeller hub and to the rotating electrical contacts 26 in the outside of the clutch assembly 21 (FIG. 5).

FIG. 4 shows the engine case 12 with the intake slot 13 and the exhaust slot 15. These slots have angled ribs, to support and clean the impeller vane seals. The electromagnet mounts 14 are on both sides of the engine case 12 and accept the electromagnets 5. The end cap mounts 16 are on both ends of the engine case 12. The fuel injector ports 17 and the fuel igniters 18 are slightly offset below the plane of the electromagnet mounts 14.

FIG. 5 shows the engine case end caps 11, which fit over the impeller hub-power shaft assembly and attach to the engine case 12, to form gas tight seals with the engine case and the impeller vanes. (The impeller vanes 2 & 3 to engine case interior wall 1 are also gas tight seals.) The magnetically disengaged, clutch ring assembly 21 fits the impeller hub in the vane plane of that hub and when engaged, rotates with the impeller hub, transferring the rotation to the power shaft.

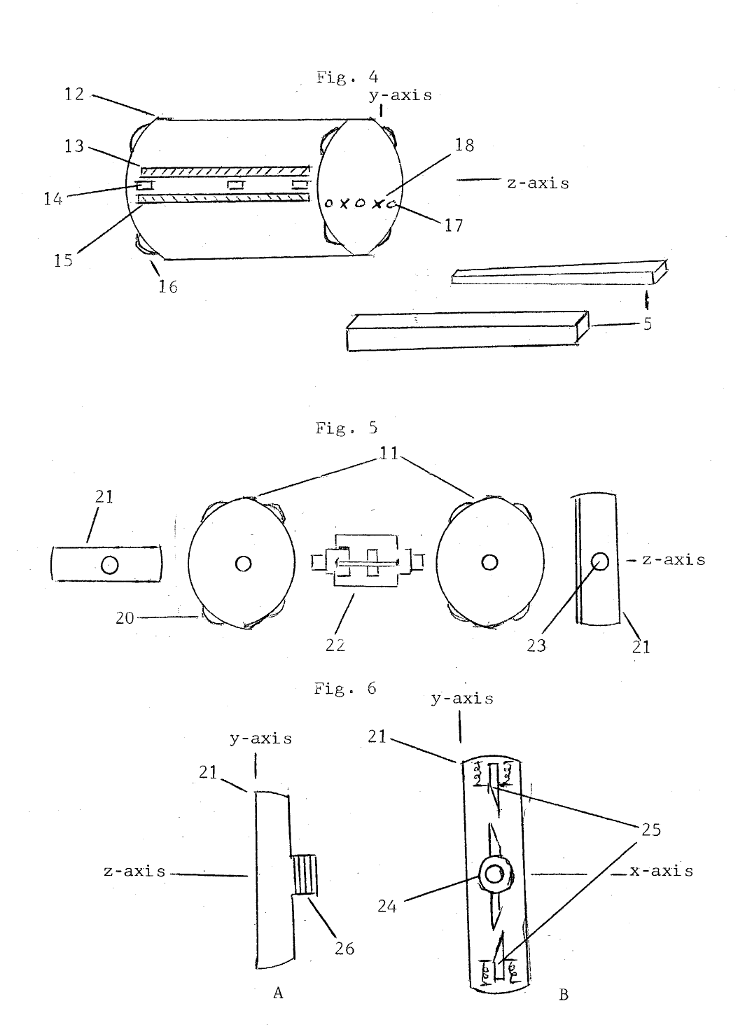

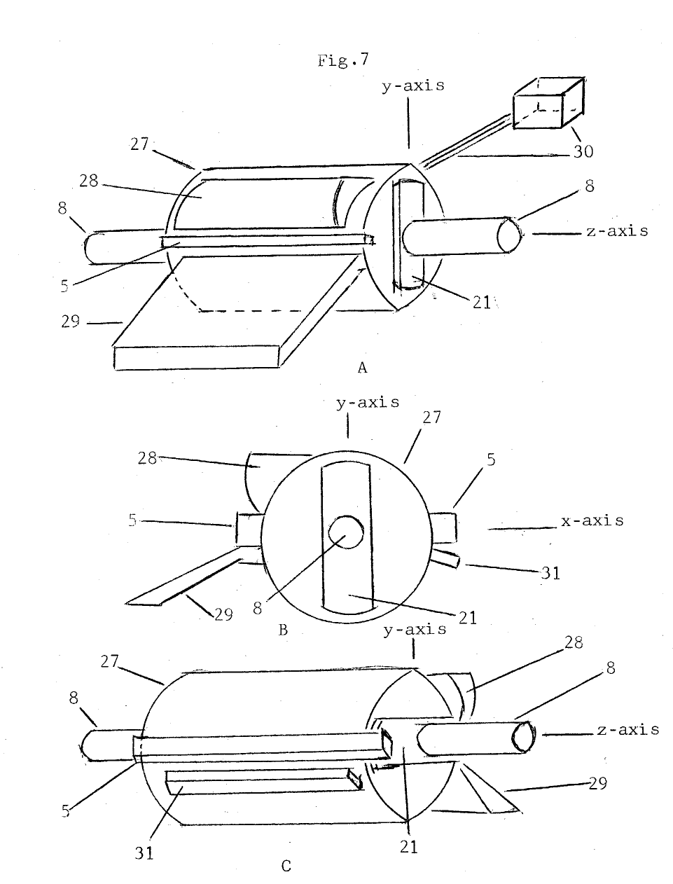

FIG. 6, right, shows a transparent view of the clutch assembly 21. The clutch actuator wedges 25, are shown in the magnetically attracted, disengaged position. When magnetically released, the spring loaded actuator wedges 25 move the fingers of the flat, helical clutch coil/ring 24, decreasing the coil/ring radius and gripping the power shaft. The electromagnets 5 extend slightly beyond the end caps 11 to attract and disengage the clutch actuator wedges, and if needed could engage the end of the clutch assembly (magnetic, pivot arm, not shown) to stop, reverse rotation of the impeller during combustion in the power sector.

The rotating electric contacts 26 on the clutch assembly 21 extension could be used to control the impeller vane electromagnets, if needed.

FIG. 7 shows an embodiment, with a usable, output power shaft 8 at each end, of the engine assembly 27. The air intake, air filter, and ozone generator unit 28 and the exhaust gas chute 29. Other embodiments may have exhaust gases impelled from the engines in different manners. The control box and wiring harness 30; control: ozone concentration, electromagnets, fuel injectors, and fuel igniters (if needed) and other functions as needed and provides initial electrical power, a generator-starter (not shown) could be on one end of the power shaft, or belt driven from the power shaft, or perhaps the electrical current possibly generated by the rotating vane electromagnets could be utilized.

Operation:

The engine cycle of page 4, FIG. 1, describes the mechanical operation of this illustrated, simple embodiment.

The electromagnetic fields are intended to aid in the transfer of momentum from the dynamic impeller to the static impeller. As the dynamic impeller approaches the static impeller, electromagnets on the engine case briefly reverse field, releasing and repelling the static impeller, momentum is transferred by the compressed air charge of the compression sector and magnetic field repulsion of the incoming dynamic impeller (during closest approach both impeller vanes have the same electromagnetic field and magnetically repel). The electromagnets on the engine case shut down briefly after repelling the static impeller. These electromagnets now generate a magnetic field to capture the incoming impeller (now static) and the cycle repeats.

Comment; there are likely to be some embodiments which alter this magnetic field cycle. The compression ratio of the flat faced impeller vanes is likely to be about 7:1; with optimized, custom-milled impeller vane faces, the compression ratio could be very high. The momentum transfer by the compressed air charge may be adequate, (balance point of compression ratio and momentum transfer and power shaft output) to eliminate need for impeller vane electromagnets.

The engine case electromagnets would release and capture the respective impeller vanes. Other embodiments could have a plurality of electromagnets built into the engine case and/or into the interior wall of the engine case, to sequence clutch disengagement relative to impeller vane capture. This class of devices might be named “electromagnetic field ratchets or clutches”.

One embodiment of clutch operation is described on page 8, FIG. 6, alternate embodiments, means to transfer impeller rotation to the power shaft, are likely to appear.

It is the Applicant's understanding that ozone has a half-life of about 20 minutes at standard conditions, and that none (zero) of the ozone generated in the intake air would survive the combustion sector to exit with the exhaust. Ozone is a very powerful oxidant, and at appropriate concentrations should initiate spontaneous combustion of hydrocarbon fuels and hydrogen fuels, well below the conditions necessary to form nitrogen oxide pollutants.

While it may vary for each fuel type. The spontaneous combustion curve of ozone concentration verses temperature/compression ratio is likely to be about:

[image]

With ozone sensors at the intake slot, temperature sensors at the combustion sector, and ozone, carbon monoxide, and nitrogen oxides sensors in the exhaust gas stream, the intake ozone concentration could be adjusted to initiate spontaneous combustion, minimize carbon monoxide and minimize nitrogen oxides.

Fuel injectors are the preferred method of fuel delivery and operate classically.

The preferred fuel igniters could be scanning, ultra-short pulse lasers. These lasers can be small (<shoebox) and could ignite an entire scanned volume of fuel-air mixture(s).

### CONCLUSION

### Ramifications and Scope

Mechanical-electromagnetic, rotary, internal combustion engines (MER), appear to be a new and largely unexplored class of engines. The use of high temperature materials and self-lubricating bearings may spawn truly remarkable engines. Multiple-vaned (greater than 2) impellers have yet to be explored. A pair of 4 bladed impellers may have an improved balance of forces. Exhaust sound suppression systems could likely contribute to environmental improvement, for example: “Neoplanar” TM, “a thin film (1/8 inch) magnetic transducer”, made by American Technology Corp., may produce “anti-sound”.

MER engines could be designed, from the beginning, to be more efficient, cleaner, and quieter than contemporary internal combustion engines.

Multiple MER engines, connected together appropriately, may “smooth out”, and produce high, power output.

Multiple, separate, MER engines, in synchronous operation, for example; one engine at each drive wheel, may inspire totally new vehicles.

1. Engines utilizing magnetic fields to control rotational momentum.

2. The engines of claim 1 wherein said engines are rotary, internal combustion, engines.

3. The rotary, internal combustion, engines of claim 2 wherein said engines are utilizing dependently rotating impellers.

4. The rotating impellers of claim 3 wherein said impellers are rotating around a shared, single axis.

5. The impellers of claim 3 wherein creating said impellers is by segment assembly.

6. The impeller segment assembly of claim 5 wherein said assembly is friction stir welded.

7. The rotating impellers of claim 3, wherein magnetic fields are controlling the momentum of said impellers.

8. The magnetic fields of claim 1 wherein electromagnets are generating said fields.

9. The engines of claim 1 wherein combustion in said engines is of ozone mixtures.

10. First means: Magnetic fields that control rotational momentum in rotary engines.

11. The rotary engines of claim 10 wherein said engines are rotary, internal combustion, engines.

12. The rotary, internal combustion, engines of claim 11 wherein said engines utilize dependently rotating impellers.

13. The impellers of claim 12 wherein said impellers are shared, single axis impellers

14. The impellers of claim 12 wherein said impellers are segment assemblies.

15. The assemblies of claim 14 wherein said assemblies are welded segments.

16. The welded segments of claim 15 wherein said segments are friction stir welded.

17. The rotating impellers of claim 12 wherein the momentum of said impellers is controlled by magnetic fields.

18. The magnetic fields of claim 10 wherein said magnetic fields are generated by electromagnets.

19. The rotary engines of claim 10 wherein combustion mixtures contain ozone.

20. Second means: ozone in the combustion mixtures of engines.
